(19) United States
(12) Patent Application Publication
(10) Pub. No.: US 2017/0308709 A1
(43) Pub. Date: Oct. 26, 2017

(54) METHOD AND APPARATUS FOR SECURE DATA TRANSFER

(71) Applicant: Peter N. Ching, Cowan Heights, CA (US)

(72) Inventor: Peter N. Ching, Cowan Heights, CA (US)

(21) Appl. No.: 15/589,772

(22) Filed: May 8, 2017

Related U.S. Application Data
(63) Continuation of application No. 11/588,614, filed on Oct. 26, 2006, now abandoned.
(60) Provisional application No. 60/731,087, filed on Oct. 28, 2005.

(51) Int. Cl. G06F 21/60

(52) U.S. Cl. CPC G06F 21/606; G06F 21/602

(57) ABSTRACT

Methods and apparatus for secure transfer of electronic or optical data. In one exemplary aspect, a method is provided whereby data on a source computer is filtered to exclude all but data that is authorized for transfer, stored in a transport format, marked so that the source of the stored data can be authenticated, and transferred to a transfer device configured to only accept data marked with an acceptable authentication mark. In one embodiment, a control apparatus is provided whereby data can be analyzed to exclude harmful code, a storage apparatus is provided whereby the analyzed data can be stored, an authentication apparatus is provided whereby data so analyzed and stored can be marked to identify the trusted nature of the analyzing apparatus and a receiving apparatus is provided whereby the recipient of the data only accepts data identified as originating from a trusted source.

### PRIORITY AND RELATED APPLICATIONS

This application is a continuation of co-owned and co-pending U.S. patent application Ser. No. 11/588,614 of the same title filed Oct. 26, 2006, incorporated herein by reference in its entirety, which claims priority to U.S. Provisional Patent Application Ser. No. 60/731,087 filed Oct. 28, 2005 of the same title, also incorporated herein by reference in its entirety. This application is related to U.S. patent application Ser. No. 10/368,123 filed Feb. 18, 2003 entitled “METHOD AND APPARATUS FOR COMPUTER-READABLE PURCHASE RECEIPTS USING MULTI-DIMENSIONAL BAR CODES” and U.S. patent application Ser. No. 11/129,538 filed May 13, 2005 entitled “MULTI-WAY TRANSACTION RELATED DATA EXCHANGE APPARATUS AND METHODS”, each of which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. Field of the Invention

This application relates to the filed of secure data/information transfer, and in one exemplary context to processing and filtration of data for, inter alia, security reasons.

### 2. Description of the Related Technology

External storage apparatus and means for transferring data from one computer to another, including but not limited to email, floppy disks, optical disks and flash memory based drives (“Flash Drives”), collectively “Transfer Medium”, can be a transmission means for computer viruses and other harmful software code transmitted without the permission of computer users (collectively “Virus Software”). Typically anti-virus software designed to identify virus software signatures is installed on user computers to identify and remove or quarantine virus software before it makes changes or otherwise installs itself on target computers.

This method has two main drawbacks. The first is that it requires that anti-virus software be installed and operating at the time the Transfer Medium is connected to the protected computer (the “Initial Connection”) so that the Transfer Medium can be scanned for “infection” at the time of Initial Connection. The second is that because the scanning process depends on having up-to-date information about what software virus code is being distributed, effective scanning requires that the anti-virus software be constantly updated so that information about newly discovered virus signatures can be added to the screening database (which poses a particular problem in the case of devices that do not normally have access to update means such as embedded devices and devices not connected to the Internet).

The need to keep anti-virus software signature databases up to date creates particular challenges in situations in which access to remote update servers is not readily available. Until recently, these situations were comparatively rare because the isolation of computers employed in such situations meant that the probabilities of Virus Software infection were reduced. Recently, however, this has become a larger issue as Transfer Mediums with significantly increased storage capabilities such as Flash Drives, have increasingly been used to connect to formerly isolated computers. For example, in September 2005, the Mazda Motor Corporation announced that its “Sassou” concept car uses a USB based Flash Drive as its ignition key. As Transfer Medium are being connected to a broader range of devices, many of which are embedded or otherwise not conveniently accessible to regular anti-virus software updates, there exists a requirement to provide an improved method for securing the Transfer Medium from infection by Virus Software.

Current art Flash Drives can be made to incorporate encryption or antivirus software enabling users to encrypt files stored on the Flash Drives and to check for virus software. That said, in the case of anti-virus software, the scan must still be run each time the Flash Drive is connected to the computer, creating inefficiencies due to the time required to conduct the scan and requiring greater computing resources be available to support the increased processing and memory demands of the anti-virus software. In the case of encryption software, while the encrypted file is protected from infection and disclosure, the encryption does not protect the entire Flash Drive from infection by the virus software.

What is needed is a way to secure the Transfer Medium from infection without requiring dedicated anti-virus software that is dependent on regular upgrades to provide it with information about Virus Software.

Virus Software detection methods such as those described in U.S. Pat. No. 6,088,803 to Tso et al.; U.S. Pat. No. 6,094,731 to Waldin et al. and U.S. Pat. No. 6,851,057 B1 to Nachenberg, each incorporated herein by reference in its entirety, are well known in the art. Write protection methods such as those described in U.S. Pat. No. 6,170,743 B1 to Okaue, et al., incorporated herein by reference in its entirety, are hardware and/or software based methods of preventing electronic data from being written to Transfer Medium, and are well known in the art.

Symmetric cryptography is a cryptographic method that uses a single numeric key to perform both encryption and decryption. DES is a well-known symmetrical cipher. Because the DES algorithm is publicly known, learning the DES key would allow an encrypted message to be read by anyone. As such, both the message sender and receiver must keep the DES key a secret from others. A DES key typically is a sequence of eight bytes, each containing eight bits. To enhance the DES integrity, the DES algorithm may be applied successive times. With this approach, the DES algorithm enciphers and deciphers data, e.g., three times in sequence, using different keys, resulting in a so-called triple DES (3DES) technique.

The Advanced Encryption Standard (AES), also known as Rijndael, is a block cipher adopted as an encryption standard by many entities including the U.S. government. It is used worldwide, as is the case with its predecessor, DES. AES was adopted by National Institute of Standards and Technology (NIST) and was codified as US FIPS PUB 197 in November 2001.

AES has a fixed block size of 128 bits and a key size of 128, 192 or 256 bits. The key is expanded using the well-known Rijndael key schedule. Most of AES calculations are performed in a special finite field. AES typically operates on a 4×4 array of bytes, termed the state. For encryption, each cycle or round of AES (except the last round) consists of four stages or operations: (i) AddRoundKey, wherein each byte of the state is combined with the round key, and each round key is derived from the cipher key by using the key schedule; (ii) SubBytes, wherein a non-linear substitution is performed such that each byte is replaced with another according to a lookup table; (iii) ShiftRows, wherein a transposition step is performed such that each row of the state is shifted cyclically a given number of steps; and (iv) MixColumns, wherein a mixing operation which operates on the columns of the state is performed, thereby combining the four bytes in each column using a function (e.g., linear transformation). The final round of the algorithm replaces the MixColumns stage with another instance of the AddRoundKey step.

AES provides a much higher level of encryption than DES or 3DES, and hence is increasingly being integrated into applications where strong protection is desired.

Asymmetric cryptography or dual key cryptography of the type taught by Whitfield Diffie and Martin Hellman is a form of encryption in which the encryption/decryption keys are numerical values that exist in matching pairs such that what one of the keys encrypts, only the matching key can decrypt. In asymmetric cryptography, typically one key of the pair is kept secret (the “Private Key”) and one key of the pair is disclosed to the public and identified as belonging to the party controlling the Private Key (the “Public Key”). Public Key Infrastructures (“PKI”) use trusted directories of information about Public Keys and their issuers in conjunction with asymmetric cryptography to provide assurances to recipients of asymmetrically encrypted files that Public Keys, and by extension information secured via asymmetric cryptography methods employing said Public Keys, indeed correspond to expected and claimed Private Key holders.

Secure hash algorithms, such as the SHA-1, SHA-224, SHA-256, SHA-384 and SHA-512 algorithms described in the U.S. Government's Federal Information Processing Standards Publication 180-2 (as amended); Ron Rivest's MD-4 and MD-5 algorithms and the Snerfu family of message digest functions developed by Ralph Merkle are well known in the art as one-way hash functions that convert variable length binary input strings into fixed length binary output strings that are a condensed representation of the electronic data contained in the binary input string (a “Message Digest”). One-way hash algorithms can be used to create secure indicators of binary file data integrity in the sense that they are designed such that for a given Message Digest created by processing a binary file with a one-way hash algorithm, it is computationally infeasible to find a different binary file that, when processed with a one-way hash algorithm, will create a second Message Digest that is identical to the Message Digest created using the first binary file. Symmetric cryptography, asymmetric cryptography, one-way hash and PKI methodologies are well known in the art.

### SUMMARY OF THE INVENTION

It is therefore an object of the present invention to provide a method and apparatus for improved data and program security and protection.

In one exemplary aspect, data on a source computer is filtered to exclude all but data that is authorized for transfer, stored in a transport format, marked so that the source of the stored data can be authenticated, and transferred to a transfer device configured to only accept data marked with an acceptable authentication mark.

According to one embodiment of the present invention, a control apparatus is provided whereby data can be analyzed to exclude harmful code, a storage apparatus is provided whereby the analyzed data can be stored, an authentication apparatus is provided whereby data so analyzed and stored can be marked to identify the trusted nature of the analyzing apparatus, and a receiving apparatus is provided whereby the recipient of the data will only accept data that is identified as originating from a trusted source.

In another aspect of the invention, apparatus adapted to securely provide filtering of data on a source device to produce filtered data is disclosed. In one embodiment, the filtering comprises excluding substantially all portions of the data except for data authorized for transfer, and the apparatus is adapted to: store the filtered data; mark the filtered data so that the source of the stored filtered data can be authenticated; and transfer the filtered and marked data to a transfer device configured to only accept data marked with an acceptable authentication mark.

In another embodiment, the apparatus is disposed on the source device, and the filtering is performed by software adapted to run on the device and configured to identify at least one of: (i) virus code, or (ii) an executable, within the data.

In another embodiment, the apparatus comprises a computerized device with software adapted to encrypt at least a portion of the data authorized for transfer. The encryption is performed using a public portion of a public-private key pair, a private portion of the pair being retained by a second device with which the apparatus is or will be in data communication with.

In another embodiment, the second device comprises a substantially portable flash drive, and the computerized device comprises a personal or laptop computer having a USB port, the USB port providing communication between the computerized device and flash drive when the drive and device are placed in communication.

In another embodiment, the apparatus is disposed on a device other than the source device, and the filtering is performed by software adapted to run on the other device and configured to identify at least one of: (i) virus code, or (ii) an executable, within the data.

In another aspect of the invention, a method of processing source data being transferred from one device to a second device is disclosed. In one embodiment, the method comprises: encrypting source data via a first apparatus to produce encrypted data; transferring the encrypted data to a second apparatus; evaluating the encrypted data to determine if at least one criterion is met; decrypting and locally storing the encrypted data if the criterion is met; and not decrypting and deleting the encrypted data if the criterion is not met.

In one variant, the second device comprises a portable flash drive, and the at least one criterion comprises being able to decrypt at least a portion of the encrypted data using a key or key portion resident on the flash drive.

In another variant, the second device comprises a portable flash drive, the method further comprises hashing at least a portion of the encrypted data to create first hashed data, and the at least one criterion comprises identically matching a hash generated by the flash device to the first hashed data.

In yet another aspect of the invention, computerized apparatus is disclosed, comprising: control apparatus adapted to analyze source data to exclude harmful code; storage apparatus adapted to store the analyzed data; authentication apparatus adapted to designate the trusted nature of the data analyzed by the control apparatus; and receiving apparatus adapted to only receive data marked as trusted.

In still another aspect of the invention, a method of processing source data is disclosed. In one embodiment, the method comprises: encrypting the source data to create encrypted source data; hashing the encrypted source data to create hashed data; encrypting the hashed data to create an encrypted hash; decrypting the encrypted hash to recover the hashed data; generating a second hash based on the encrypted source data; comparing the recovered hash data and the second hash; and if the comparing meets at least one criterion, then performing further processing on at least the encrypted source data.

In one variant, the encrypting the source data to create encrypted source data, hashing the encrypted source data to create hashed data, and encrypting the hashed data to create an encrypted hash are all performed on a first computerized device; and the decrypting the encrypted hash to recover the hashed data, generating a second hash based on the encrypted source data, and comparing the recovered hash data and the second hash are all performed on a second computerized device.

In another variant, the second computerized device comprises a portable storage medium device having a software process capable of running thereon, the software process adapted to perform the decrypting the encrypted hash to recover the hashed data, generating a second hash based on the encrypted source data, and comparing the recovered hash data and the second hash before permitting storage of the source data on the second device.

In another variant, the encrypting the source data to create encrypted source data, and the encrypting the hashed data to create an encrypted hash, are each performed using the same encryption key. The encryption key comprises the public portion of a public-private key pair or alternatively a symmetric encryption key.

In still another variant, the method further comprises processing the source data before the encryption thereof is performed, the processing being adapted to identify at least one target element within the source data. The at least one target element within the source data is selected from the group consisting of: (i) virus code; and (ii) an executable.

### BRIEF DESCRIPTION OF THE DRAWINGS

The above and other features and advantages of the present invention are hereinafter described in the following detailed description of illustrative embodiments to be read in conjunction with the accompanying drawings and figures, wherein like reference numerals are used to identify the same of similar system parts and/or method steps, and:

FIG. 1 is a diagram illustrating the basic components of an exemplary system conforming to the principles taught in the instant invention.

FIG. 2 is a block diagram illustrating the basic components of both sending and receiving computer systems for processing and sending data conforming to the principles taught in the instant invention.

FIG. 3 is a block diagram illustrating the basic components of a transfer device conforming to the principles taught in the instant invention.

FIG. 4 is a logical flowchart illustrating one generalized embodiment of the method of transferring data according to the present invention.

FIG. 4a is a logical flowchart of an exemplary method of securely processing and transmitting data according to the generalized method of FIG. 4.

FIG. 5 is a logical flowchart showing an alternate method of sending data with assurances that unintended software code is not being included in the transmission

FIG. 6 is a logical flowchart showing an alternate method of sending data with assurances that unintended software code is not being included in the transmission and with additional assurances that the Combined File has not been modified between the time it was created by the Source Software and the time it is processed by the TM Software.

### DETAILED DESCRIPTION OF THE INVENTION

The following descriptions are exemplary embodiments of the invention and are not intended to limit the scope, applicability or configuration of the invention in any way. Rather, the following description is intended to provide convenient illustrations for implementing various embodiments of the invention. It will be appreciated by one skilled in the art that various additions, substitutions or deletions may be made in the function and arrangement of the elements described in these embodiments (as well as the sequence and content of steps described herein) to ascertain and/or realize any number of other benefits without departing from the spirit and scope of the instant invention.

It will be further understood by one skilled in the art, that while the exemplary embodiment disclosed below contemplates execution of programs and storage of information using a combination of Sender and Destination computers and a transfer device, the specific platform assigned to executing a particular program and subfunction thereof maybe changed, added to or reduced without departing from the spirit and scope of the instant invention.

Further, one skilled in the art will also realize that alternate storage, processing and transport apparatus, including but not limited to personal digital assistants, cellular phones and Bluetooth, WiMax, RFID, TCP/IP and WiFi based devices may alternatively be substituted for or used in combination with various elements of the system disclosed herein without departing from the spirit and scope of the invention.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “network” refers generally to any type of telecommunications or data network including, without limitation, hybrid fiber coax (HFC) networks, satellite networks, telco networks, and data networks (including MANs, WANs, LANs, PANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.)

As used herein, the term “interface” refers to any signal or data interface with a sub-component, component or network including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, WiFi (802.11a,b,g,n), WiMAX (802.16), PAN (802.15), or IrDA families.

As used herein, the term “Wi-Fi” refers to, without limitation, any of the variants of IEEE-Std. 802.11 or related standards including 802.11 a/b/g/n.

As used herein, the term “wireless” means any wireless signal, data, communication, or other interface including without limitation Wi-Fi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

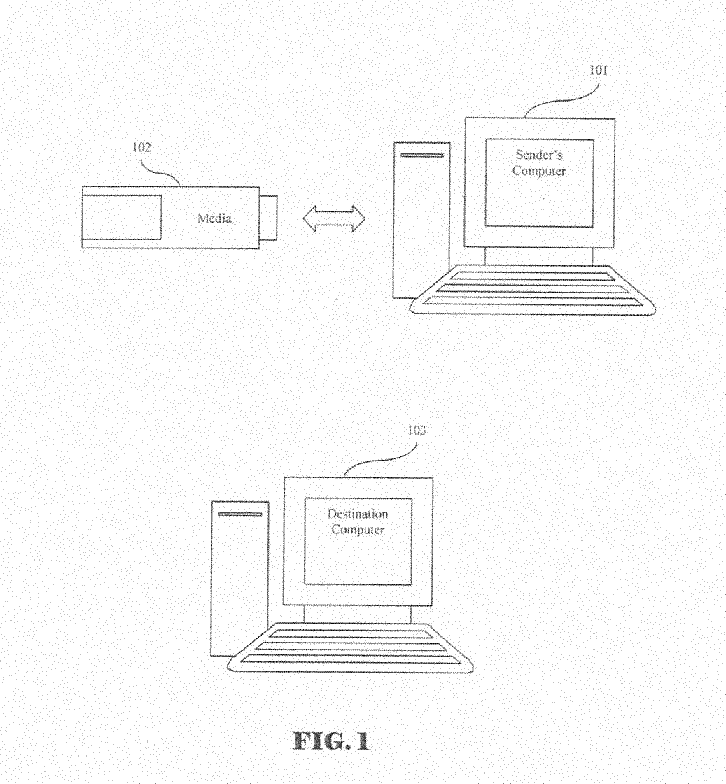

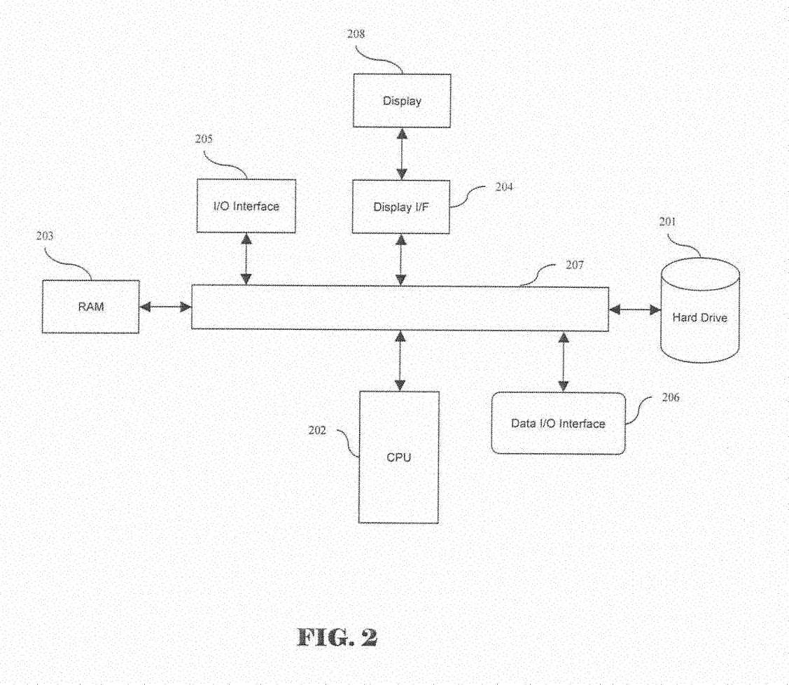

In FIG. 1, the basic components of an exemplary system conforming to the principles taught in the instant invention are shown. The Sender's Computer 101 (as shown in greater detail in FIG. 2) is in wired or wireless communication with Transfer Medium (TM) 102. The Transfer Medium 102 includes a microprocessor or other integrated circuit (not shown) that runs a software program or otherwise implements logic that “write protects” the Transfer Medium; e.g., so that only data marked with a descriptor (e.g., Bypass Tag, as defined below) can be written to the Transfer Medium 102.

Once the Transfer Medium arrives at the desired location, the Transfer Medium is connected to the Destination Computer 103 (which is substantially in the same form as is shown for the Sender's Computer 101). After the Transfer Medium 102 is connected to or otherwise placed in data communication with the Destination Computer 103, Data will be transferred from the Transfer Medium 102 to the Destination Computer 103.

Note that the two communication links (i.e., sender to TM, and TM to destination) may also be established concurrently, such that the two links effectively form a channel through the TM 102. For example, the data may be buffered across both links, and flow control mechanisms of the type well known in the data processing arts employed to maintain data flow from the sending computer device to the destination device through the TM.

In FIG. 2, the diagram illustrates the basic components of an exemplary computer system for processing and sending data (a “Sender's Computer” 101). The system consists of a hard drive 201, a CPU 202, random access memory (RAM) 203, a display interface (a “Display I/F”) 204, an input/output interface 205 (“I/O Interface”) and a data input/output means 206 (such as a keyboard and a mouse pointing device) (the “Data I/O Interface”) are all connected to each other via one or more data buses 207. A display 208 is additionally attached to the Display I/F 204. Software (not shown) for capturing and processing data for transfer (“Source Software”) is stored on the hard drive 201. The Source Software, when executed on the CPU 202 enables users to enter data (“Data”) through the Data I/O Interface 206 for processing. The Source Software, in one exemplary configuration, is programmed to only accept ASCII data and will not allow users to attach files containing executable code or other forms of information desired to be potentially precluded from transfer.

It will be appreciated that while the Sender's Computer and Destination Computer are shown in the illustrated embodiment as effectively personal computers, these devices 101, 103 may literally take any form, including without limitation laptops, PDAs, cellular telephones or smartphones, handheld computers, personal media devices (PMDs), and so forth.

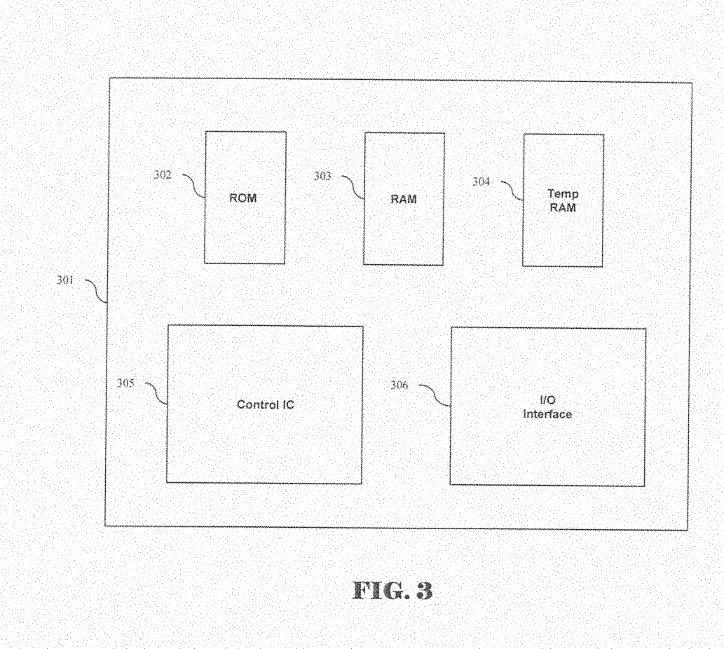

In FIG. 3, the diagram illustrates the basic elements of a transfer device conforming to the principles taught in the instant invention. The transfer device 301 incorporates read only memory (“ROM”) 302, a RAM 303, additional temporary RAM 304, a control integrated circuit 305 (“Control IC”) with digital processor and an input/output interface 306 (“I/O Interface”). Software (not shown) stored in ROM 302 (the “TM Software”) is set by default to prevent any Data other than specifically authorized Data from being written into RAM 304. In this capacity, the TM Software acts effectively as a gatekeeper for the RAM 304. It will be recognized, however, that other mechanisms may be employed for fulfilling this function, including firmware stored within another component or device. For example, an alternate embodiment of the invention requires the TM to be in data communication with a second device which stores the necessary code to implement (enable) the gatekeeper function. This second device might comprise the Sender Computer 101, or yet another device (e.g., a wireless-enabled device) from which the TM can secure the requisite code or portion thereof.

While the embodiment of FIG. 3 shows implementation of at least some of the various “gatekeeping” functions on the TM or transfer device, it will be appreciated that some or all of these functions may be implemented on the source device 101 as well. Stated simply, the goal is to prevent unwanted or unauthorized transfer of data, virus, etc. from one device to another across an interface, and hence the “gatekeeper” or protective functions can be implemented on either side of that interface, or on both sides if desired (either in a duplicative or distributed manner).

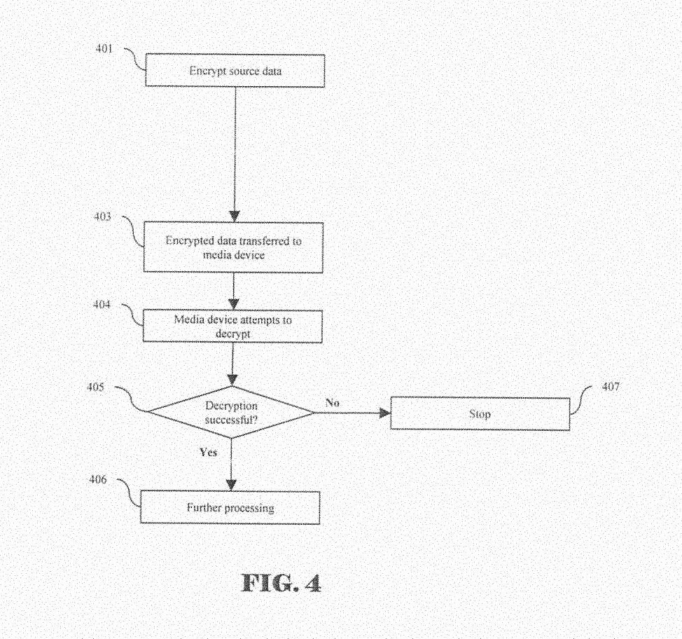

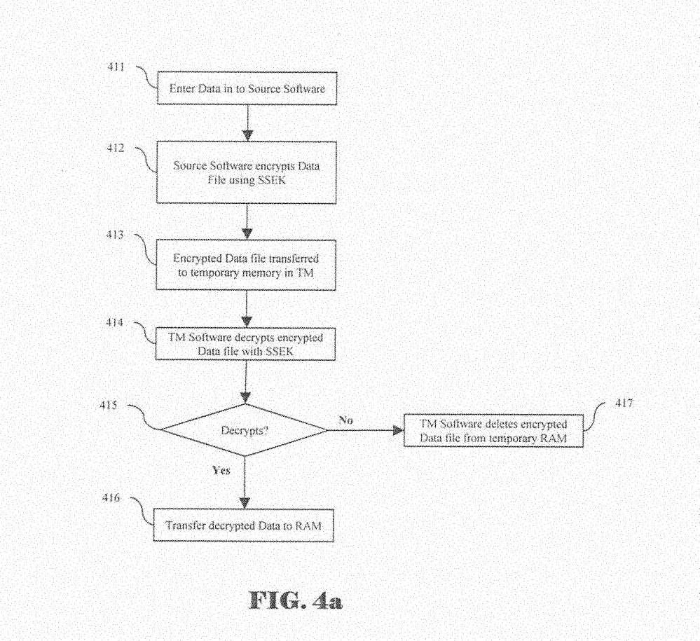

FIG. 4 is a logical flow diagram illustrating one generalized embodiment of the method of transferring data according to the present invention. As shown in FIG. 4, the method starts by encrypting source data, such as via Source Software installed on the aforementioned Sender's Computer 101 (step 401). The encrypted data is then transferred to a Transfer Medium 102 (step 403). The Transfer Medium 102 attempts to decrypt the encrypted data (step 404). If the encrypted data decrypts successfully, the TM enables further processing of the decrypted data, or even the data in encrypted form (step 406). If the encrypted data does not decrypt successfully, the process is terminated, or the data deleted from the TM (step 407).

FIG. 4a is a logical flowchart showing one embodiment of a method of sending data, optionally with assurances that unintended software code or other data or structures is not being included in the transmission. Data is entered directly into the Source Software installed on the aforementioned Sender's Computer 101 (step 411). The Source Software can then optionally scan the data for executable code or other prohibited elements or structures, and filter such code or elements/structures out (or prohibit further processing altogether). The Source Software then employs a symmetrical encryption algorithm to encrypt the (permitted) data entered into the Source Software using a single secret encryption key (the “SSEK”) (step 412). The encrypted Data is then transferred to the aforementioned temporary RAM 304 in the aforementioned Transfer Medium 102 (step 413). The aforementioned Control IC 305 on the Transfer Medium 102 executes software stored on the aforementioned Transfer Medium ROM 302 (the “TM Software”) that “write protects” the Transfer Medium 102 so that only data encrypted with the SSEK can be written to the Transfer Medium 102. The TM Software accomplishes this by attempting to decrypt the encrypted Data using the SSEK (which is known to the TM Software) (step 414). If the encrypted Data decrypts successfully, the TM Software writes the decrypted Data to the RAM 303 on the Transfer Medium 102 (step 416). If the encrypted Data does not decrypt successfully, the TM Software deletes the encrypted Data from the temporary RAM 304 (step 417).

The method of FIG. 4 can also make use of a cryptographic hash if desired; e.g., in complement with the symmetric key so as to provide assurances of non-modification of the data.

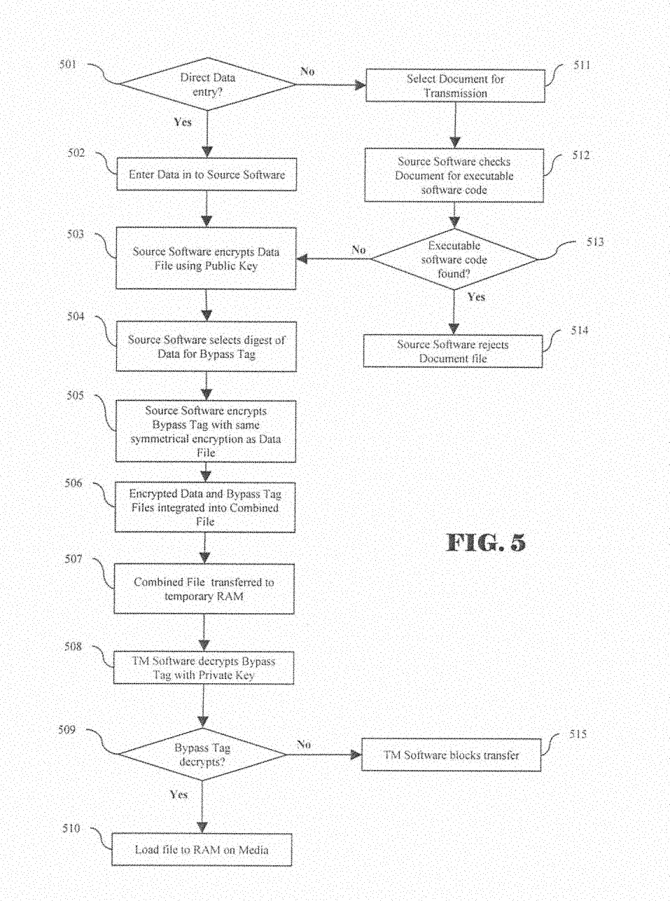

FIG. 5 is a logical flowchart showing an alternate method of sending data with assurances that unintended software code is not being included in the transmission. The user has the option of entering Data directly into the Source Software installed on the aforementioned Sender's Computer 102 (step 502) or selecting a document file (a “Document”) for processing using the Source Software (step 511).

If the user elects to enter Data directly into the Source Software, the Source Software then employs an asymmetrical encryption algorithm to encrypt the entered Data using a Public Key (the “Designated Public Key”) that corresponds to a specific user selected Private Key (the “Designated Private Key”) that has been programmed into the TM Software (step 503). The Source Software also selects a material subportion of the Data as a sample (a “Bypass Tag”) (step 504) and encrypts the Bypass Tag using the same Public Key (step 505). The encrypted Data and the Bypass Tag are integrated into single file (collectively the “Combined File”) (step 506). The Combined File is then transferred to temporary RAM 304 in the Transfer Medium 202 (step 507). The Control IC 305 on the Transfer Medium 202 executes software stored on the Transfer Medium ROM 302 (the “TM Software”) that “write protects” the Transfer Medium 202 so that only Data that can be decrypted with the Designated Private Key can be written to the Transfer Medium 202. The TM Software accomplishes this by attempting to decrypt the Bypass Tag using the Designated Private Key (step 508). If the encrypted Bypass Tag decrypts successfully, the TM Software decrypts the encrypted Data file using the Private Key and writes it to the RAM 303 on the Transfer Medium 202 (step 510). If the Bypass Tag does not decrypt successfully, the TM Software does not attempt to decrypt the encrypted Data file and deletes the Combined File from the temporary RAM 304 (step 515) or otherwise terminates processing.

It should be understood that the use of the Bypass Tag is an optional feature of the instant invention intended to reduce the time required to encrypt and decrypt Data (i.e., by reducing the volume of encrypted data that must be evaluated using the TM's private key before attempting to decrypt the entire substantive data file or structure that was encrypted). In this capacity, the relationship of the size of the encrypted Bypass Tag and the actual encrypted substantive data file can be viewed as a “compression ratio” of sorts. This ratio can be used as the basis of, or determined by, a speculative type approach. For example, if the Source Software detects the size of the data or file to be encrypted is comparatively large, it can speculate that the use of the Bypass Tag approach may save processing overhead or time (on average) since the decision not to decrypt the remainder of the Combined File may occur with sufficient frequency, and hence the use of the Bypass tag in such instances would avoid having to attempt to decrypt the larger files. Stated differently, for smaller files or structures, it may be just as fast to not create a Bypass Tag at all, and simply encrypt and attempt to decrypt the substantive or complete file right away.

Moreover, the use of the Bypass Tag may be incorporated into the methodologies of FIGS. 4 and 4a as desired.

Hence, the steps involving the Bypass Tag may be added or omitted without substantially departing from the novel principles taught herein.

If the user elects to import a Document into the Source Software, the Source Software then scans the Document for executable code or other prohibited elements or structures (step 512). If the Source Software finds executable code, etc., it displays a warning message to the user and rejects the Document (step 514). If the Source Software does not find executable code, it then employs an asymmetrical encryption algorithm to encrypt the Document using a Public Key (the “Designated Public Key”) that corresponds to a specific user selected Private Key (the “Designated Private Key”) that has been programmed into the TM Software (step 503). The Source Software also selects a material subportion of the Document as a sample (a “Bypass Tag”) (step 504) and encrypts the Bypass Tag using the same Public Key (step 505). The encrypted Document and the Bypass Tag are integrated into single file (step 506) (collectively the “Combined File”). The Combined File is then transferred to temporary RAM 304 in the Transfer Medium 202 (step 507). The Control IC 305 on the Transfer Medium 202 executes software stored on the Transfer Medium ROM 302 (the “TM Software”) that “write protects” the Transfer Medium 202 so that only if the Document can be decrypted with the Designated Private Key can it be written to the Transfer Medium 202. The TM Software accomplishes this by attempting to decrypt the Bypass Tag using the Designated Private Key (step 508). If the encrypted Bypass Tag decrypts successfully, the TM Software decrypts the encrypted Document using the Private Key and writes it to the RAM 303 on the Transfer Medium 202 (step 510). If the Bypass Tag does not decrypt successfully, the TM Software does not attempt to decrypt the encrypted Document and deletes the Combined File from the temporary RAM 304 (step 515).

As noted above, it should be understood that the use of the Bypass Tag is an optional feature of the instant invention intended to reduce the time required to encrypt and decrypt the Document. Alternatively, the steps involving the Bypass Tag may be omitted without substantially departing from the novel principles taught herein.

It should be further understood that in addition to or instead of scanning the Document for executable code, antivirus software may be employed to scan the software for Virus Software signatures without substantially departing from the novel principles taught herein. In addition, it should also be understood that alternate methods of encryption or hashing, including but not limited to reversing the use of the Public and Private Keys or increasing the number or type of encryption keys may be employed without substantially departing from the novel principles taught herein.

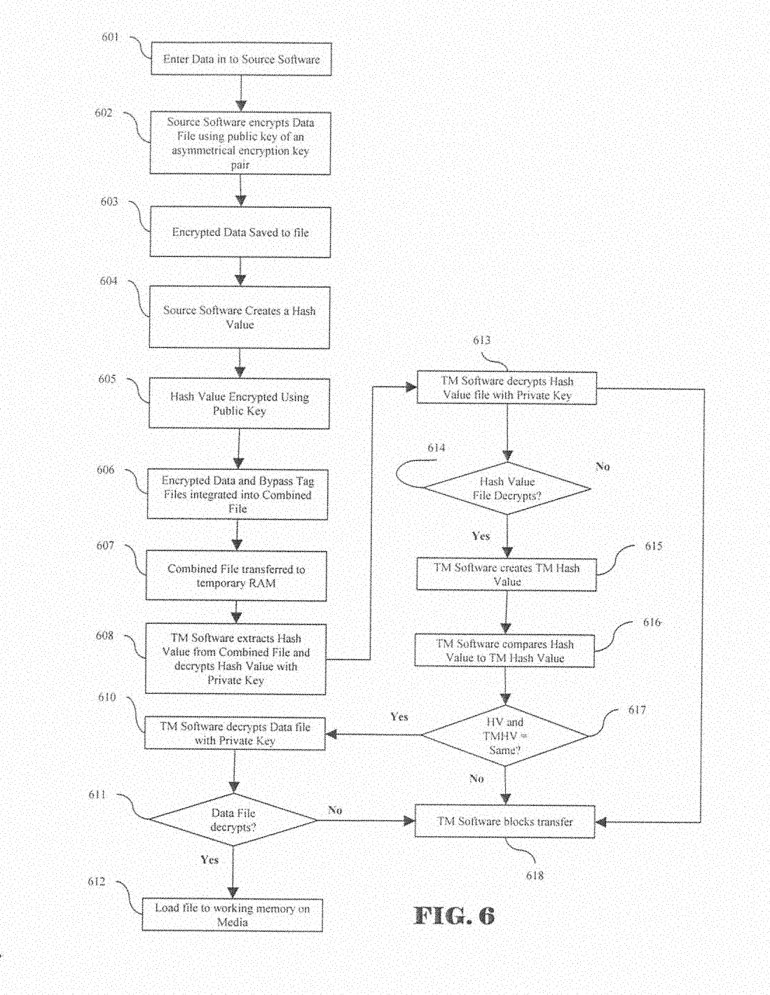

FIG. 6 is a logical flowchart showing yet another alternate method of sending data with assurances that unintended software code is not being included in the transmission. Here, additional assurances that the Combined File has not been modified between the time it was created by the Source Software and the time it is processed by the TM Software are provided. In the illustrated embodiment. the user enters Data directly into the Source Software (step 601). The Source Software employs an asymmetrical encryption algorithm to encrypt the entered Data using a Public Key (the “Designated Public Key”) that corresponds to a specific user selected Private Key (the “Designated Private Key”) that has been programmed into the TM Software (step 602). The Source Software then saves the encrypted Data to a file (step 603). The Source Software then employs a secure hash algorithm (a “SHA”) to create a one-way hash value of the encrypted Data file (a “Hash Value”) (step 604). The Source Software then employs an asymmetrical encryption algorithm to encrypt the Hash Value using the same Public Key and then saves it to a file (step 605). The encrypted Data and the encrypted Hash Value file are integrated into single file (collectively the “Combined File”) (step 606). The Combined File is then transferred to temporary RAM 304 in the Transfer Medium 202 (step 607). The Control IC 305 on the Transfer Medium 202 executes software stored on the Transfer Medium ROM 302 (the “TM Software”) that “write protects” the Transfer Medium 202 so that only Data that can be decrypted with the Designated Private Key and that, when decrypted, matches the Hash Value, can be written to the Transfer Medium 202. The TM Software accomplishes this by extracting the Hash Value file from the Combined File and then attempting to decrypt the Hash Value file using the Designated Private Key (step 613). If the encrypted Hash Value decrypts successfully, the TM Software then uses the same SHA (which has been incorporated into the TM Software) to create a hash value for the encrypted Data file (a “TM Hash Value”) (step 615). The TM Software then compares the Hash Value to the TM Hash Value (step 616). If the Hash Value and the TM Hash Value are the same, the TM software then decrypts the encrypted Data file using the Private Key (step 610) and writes it to the RAM 303 on the Transfer Medium 202 (step 612). If the Hash Value and the TM Hash Value are not the same, the TM Software does not attempt to decrypt the encrypted Data file and deletes the Combined File from the temporary RAM 304 (step 618).

The hashing-based approach of FIG. 6 can also be employed in a “Bypass Tag” fashion; e.g., where only a portion of the encrypted file is hashed, and then this hash evaluated to determine whether to decrypt or process the remainder of the encrypted data structure.

It will be recognized that while certain aspects of the invention are described in terms of a specific design examples, these descriptions are only illustrative of the broader methods of the invention, and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1-22. (canceled)

23. A method of processing source data, comprising:
determining an amount of source data;
when said amount of said source data is above a minimum threshold:
encrypting said source data at a source device to create encrypted source data;
extracting a sample subportion of said source data representing a bypass tag;
encrypting said bypass tag to create an encrypted bypass tag; and
combining said encrypted bypass tag and said encrypted source data to create a single data structure; and
transmitting said single data structure from said source device to a receiving device;
wherein said receiving device is configured to determine whether to store said encrypted source data based at least in part on a decryption result of said encrypted bypass tag or said single data structure.

24. The method of claim 23, wherein said extracting said sample subportion comprises selecting said sample subportion of said source data according to a compression ratio.
